(19) United States
(12) Patent Application Publication
(10) Pub. No.: US 2014/0313073 A1
(43) Pub. Date: Oct. 23, 2014

(54) METHOD AND APPARATUS FOR ESTABLISHING COMMUNICATIONS WITH A SATELLITE

(71) Applicants: Carlo DiNallo, Plantation, FL (US); Nathan Cummings, Gaithersburg, MD (US)

(72) Inventors: Carlo DiNallo, Plantation, FL (US); Nathan Cummings, Gaithersburg, MD (US)

(21) Appl. No.: 14/214,138

(22) Filed: Mar. 14, 2014

Related U.S. Application Data
(60) Provisional application No. 61/799,183, filed on Mar. 15, 2013.

(51) Int. Cl. H04B 7/185; H01Q 3/34

(52) U.S. Cl. CPC H04B 7/18513; H01Q 3/34
USPC 342/352; 342/368

(57) ABSTRACT

A mobile satellite radio equipped with a phased array antenna configures the phased array antenna in one or more non-directional operating modes in order to initially detect a signal from a communication satellite. Once a signal has been received from the satellite, frequency information determined in the course of operating in the one or more non-directional modes is used to configure the mobile satellite radio for operation in a subsequent stage when the phased array antenna is configured in a directional mode. In the subsequent stage the phased array antenna is used to scan a solid angle space to determine the direction of the satellite. Thereafter the antenna is used in the directional mode for satellite communication.

### RELATED APPLICATION DATA

This application is based on provisional U.S. patent application Ser. No. 61/799,183 filed Mar. 15, 2013.

### FIELD OF THE INVENTION

The present invention relates to satellite communications.

### BACKGROUND

While cellular telephone networks and wireless local area networks (LANs) provide ready access to global communication networks from cities, suburbs and even rural areas in the developed world, there are still vast areas of the world where access to communication via the aforementioned wireless communications or via regular telephone networks is not available. In such instances communications via satellites is a viable option. Satellite communications can be useful to a variety of civilian and military users.

Various companies and consortia have placed constellations of communication satellites in orbit around the earth for the purpose of providing communication in remote locations. Some such satellites are in geosynchronous orbits and some are in lower, shorter period orbits.

Geosynchronous satellites have the advantage that they provide persistent communications for the area that they serve. Disadvantageously, there is a lag in communications through geosynchronous satellites due to time required for signals to travel to and from satellites in geosynchronous orbits. Additionally geosynchronous satellites by virtue of their location at or near the equatorial plane do not provide service to the polar regions.

Communications satellites in lower, shorter period orbits resolve the communication lag issue and are able to serve the polar region. However disadvantageously, the shorter period orbits do not provide persistent communication connectivity because the satellite rapidly traverses from horizon to horizon while communications are taking place. For example from a user's perspective a short period satellite might traverse from horizon to horizon in a few minutes.

To communicate with the communication satellites, a mobile satellite radio is used. The mobile satellite radio can be a handheld device or attached to a mobile object such as, for example, a sea, land or air conveyance. Such mobile satellite radios either include an affixed antenna or are adapted to connect to an external antenna. The antenna may be an omnidirectional antenna or a directional antenna. A directional antenna offers the advantage of higher directivity or gain which leads to a higher link budget. With a directional antenna, higher data rates can be attained for a given transmit power or for a given receiver sensitivity. On the other hand directional antennas must be properly oriented towards a satellite with which they are communicating.

Operation of a mobile satellite radio may be initiated when location of the radio is not known and the terrain may be sloped. In these circumstances the direction of satellite, even if it is fixed, is not known. Additionally, satellites may serve different zones with different frequencies and the zone and corresponding frequency of any given geographic location where it is desired to initiate satellite communication may not be known at the outset. Thus for a directional antenna one would need to try different frequencies and for each frequency one would need to scan the aiming direction of the antenna through a solid angle search space (i.e., varying both elevation and azimuth directions). For geostationary satellites it is possible, if the position of the satellite and longitude and latitude of the terminal are known, to determine the correct pointing direction. However, it can be a time consuming process and may be burdensome especially in the case of time sensitive, mission critical communications.

What is needed is a method to rapidly establish satellite communications.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a schematic representation of a satellite communication system;

FIG. 2 is a block diagram of a mobile satellite radio;

FIG. 3 is a block diagram of a modular mobile satellite radio according to an alternative embodiment of the invention;

FIG. 4 is a perspective view of an antenna element array of a phased array antenna according to an embodiment of the invention;

FIG. 5 is 3-D directivity plot for the antenna element array shown in FIG. 4 when configured to operate in a first non-directional mode;

FIG. 6 is 3-D directivity plot for the antenna element array shown in FIG. 4 when configured to operate in a second non-directional mode; and

FIG. 7 is a flowchart of a method of operating the mobile satellite radios shown in FIGS. 1-3 according to an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

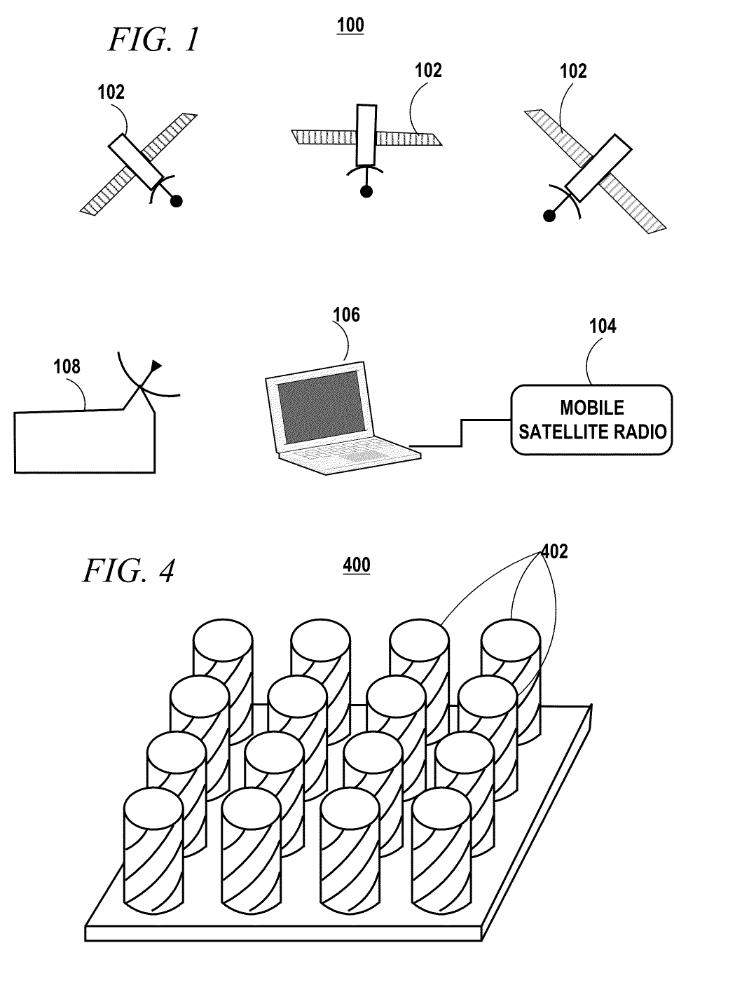

FIG. 1 is a schematic representation of a satellite communication system 100. The satellite communication system 100 includes a constellation of communication satellites 102. A mobile satellite radio 104 is used to communicate with and through the satellites 102. The mobile satellite radio 104 is communicatively coupled to a laptop computer 106, so that computer communications such as videoconferencing, email, and World Wide Web browsing may be conducted via satellite. The satellites 102 communicate with one or more ground stations 108 (only one of which is shown). The ground stations 108 are coupled to the regular terrestrial telephone network or other network (not shown). The satellites 102 will relay communications from the mobile satellite radio 104 to the ground station 108 from which they will be coupled to terrestrial or other networks. Communications will also flow in the reverse direction.

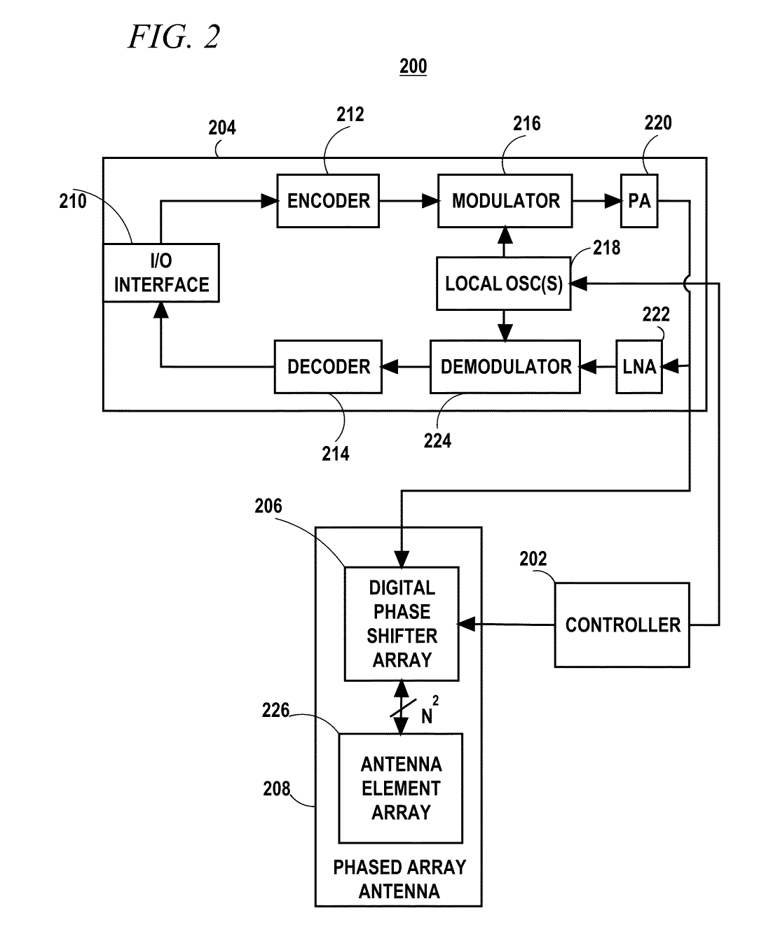

FIG. 2 is a block diagram of a mobile satellite radio 200 according to an embodiment of the invention. FIG. 2 shows one possible embodiment of the mobile radio 104 shown in FIG. 1. The mobile satellite radio 200 includes a controller 202 coupled to a transceiver 204 and to a digital phase shifter array 206 of a phased array antenna 208.

The transceiver 204 comprises an input/output (I/O) interface 210 coupled to an encoder 212 and a decoder 214. The I/O interface 210 is useful for coupling to external data sources and/or data sinks such as the laptop computer 106. The I/O interface 210 may, for example, comprise an industry standard interface such as a Universal Serial bus (USB) port.

The encoder 212 is coupled to a modulator 216. At least one local oscillator 218 is also coupled to the modulator 216. The modulator 216 modulates a carrier signal generated by the local oscillator 218 based on input from the encoder 212. The output of the modulator 216 is coupled to a power amplifier 220.

A low noise amplifier 222 is coupled to a demodulator 224. The at least one local oscillator 218 is also coupled to the demodulator 224. The output of the demodulator 224 is coupled to the decoder 214.

Both the power amplifier 220 and the low noise amplifier 222 are coupled to the digital phase shifter array 206. The digital phase shifter array 206 suitably comprises one digitally controlled phase shifter for each antenna element (402, FIG. 4) of an antenna element array 226.

The controller 202 is coupled to the at least one local oscillator 218 and is able to set the at least one local oscillator 218 to one of multiple operating frequencies so as to configure the transceiver 204 to receive signals in one of multiple frequency bands. The controller 202 is also coupled to the digital phase shifter array 206 and is able to set the phase shift of signals coupled to and from each element 402 (FIG. 4) of the antenna element array 226. By appropriately setting the phase shift for each antenna element the controller 202 is able to configure the phased array antenna 208 into a directional antenna configuration and steer the aim direction of maximum gain to different directions. Operation of a phased array antenna in a directional configuration is known to person's of ordinary skill in the art.

The controller 202 can also set the phase shift for each antenna element 402 (FIG. 4) to such relative values as to configure the phased array antenna 208 into a non-directional configuration.

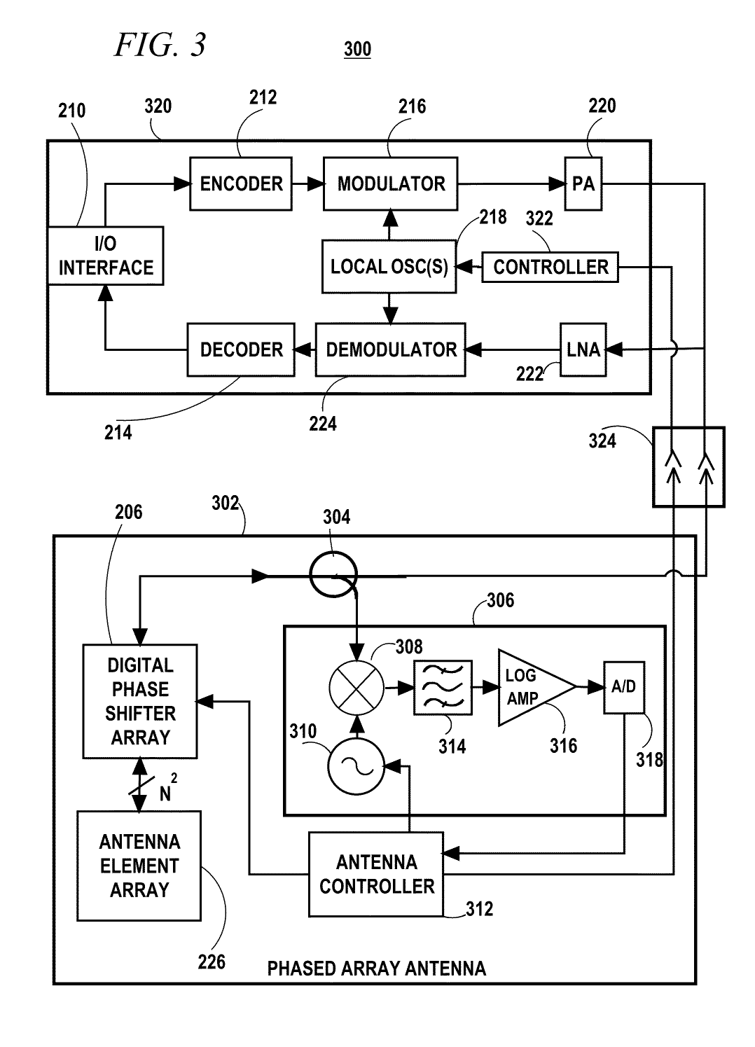

When the antenna is set to a non-directional mode it is able to receive signals from a greater range of directions, and in principle could detect satellites situated somewhere in such a range of direction, however in such a non-directional mode the signal output by the phased array antenna 208 will be much weaker and in certain cases too weak for relatively high data rate communications, due to the lower link budget. Nonetheless the transceiver 204 (and transceiver 320 shown in FIG. 3, and internal receiver 306 shown in FIG. 4) can be used to detect the signal.

FIG. 3 is a block diagram of a modular mobile satellite radio 300 according to an alternative embodiment of the invention. FIG. 3 shows another possible embodiment of the mobile radio 104 shown in FIG. 1. The modular mobile satellite radio 300 includes a separate phased array antenna 302 that includes a directional coupler 304 the routes a portion of received signals that are output by the digital phase shifter array 206 to an internal receiver 306. Within the internal receiver 306 signals received from the directional coupler 304 are routed to a mixer 308 which also receives signals from a tunable second local oscillator 310. The tunable second local oscillator 310 is coupled to and receives frequency control signals from an antenna controller 312. The mixer 308 is coupled to and outputs signals to a band pass filter 314. The band pass filter 314 is coupled to and outputs signals to a log amplifier 316 which in turn is coupled to and output signals to analog-to-digital converter 318. The antenna controller 312 is also coupled the digital phase shifter array 206 and can set the phase delays of each phase shifter in the digital phase shifter array 206 to steer the gain pattern when the phased array antenna 302 is configured in a directional mode or to configure the phased array antenna 302 into one or more non-directional modes. The modular satellite mobile radio 300 has a main transceiver 320 that in addition to the components included in the transceiver 204 shown in FIG. 2 has an internal controller 322. The antenna controller 312 is coupled to the internal controller 322 of the transceiver 320 and communicates frequency information so that the internal controller 322 of the main transceiver 320 is able to tune the transceiver to an active satellite frequency based on information received from the antenna controller 312. The phased array antenna 302 is detachably coupled to the main transceiver 320 through a set of connectors 324. Thus the phased array antenna 302, having the advanced functionality described herein can be used with existing equipment.

In operation the antenna controller 312 sets phase delays of the digital phase shifter array 206 so as to put the phased array antenna 302 into one or more non-directional modes and then successively tunes the tunable local oscillator 310 to a set of frequency channels while monitoring the output of the analog-to-digital converter 318 to which it is coupled in order to search the set of frequency channels for an active satellite channel. According to certain embodiments the antenna controller 312 simply checks for any signals having energy meeting a predetermined threshold. According to other embodiments the antenna controller checks for signals having a certain envelope modulation pattern. After an active satellite channel has been located while operating the phased array antenna 302 in one or more non-directional modes, the antenna controller 312 reconfigures the phased array antenna 302 into a directional mode and begins a search through a solid angle search space in order to determine the angular coordinates of the satellite that emitted the signals that were detected while operating the antenna 302 in the one or more non-directional modes. If the satellite is not in geosychronous orbit, or if the modular mobile satellite radio 300 is itself in motion the antenna controller 312 can then operate the phased array antenna 302 to track the satellite.

FIG. 4 is a perspective view of an antenna element array 400 of the phased array antennas 208, 302 according to an embodiment of the invention. FIG. 4 shows one possible embodiment of the antenna element array 226 shown in FIG. 2 and FIG. 3. As shown in FIG. 4 the antenna element array 400 is a 4 by 4 array of antenna elements 402 (only three of which are numbered to avoid crowding the drawing). Each antenna element 402 of the antenna element array 400 is a quadrifilar helical antenna. According to alternative embodiments of the invention array sizes other than 4 by 4 are used. Also the array 400 need not necessarily be a square array, but could be rectangular, circular, hexagonal or have a different configuration. According to alternative embodiments, in lieu of quadrifilar helical antenna elements, different types of antenna elements are used, for example, patch antenna elements or slot antenna elements.

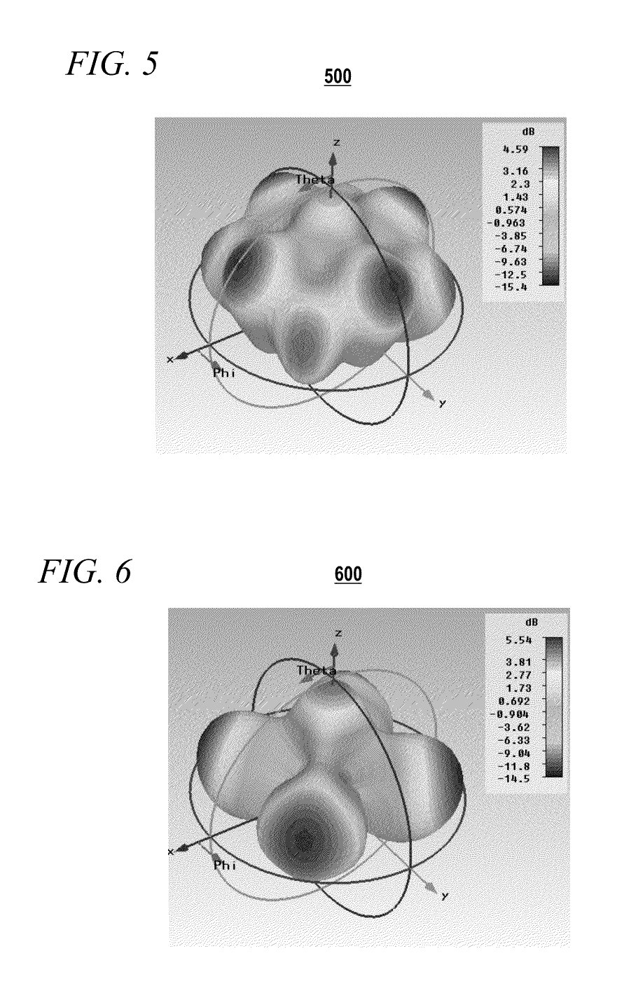

FIG. 5 is 3-D directivity plot 500 for the antenna element array 400 shown in FIG. 4 when configured to operate in a first non-directional mode. This first non-directional pattern is distinguished from the usual directional patterns which are produced by phased array antennas. A set of phase shifts that can be established by the digital phase shifter array 206 in order to configure the phased array antenna 208 to produce the directivity pattern shown in FIG. 5 is shown in table I below.

TABLE I

| | | | |
|---|---|---|---|
| 105° | 0° | 0° | 105° |
| 0° | −105° | −105° | 0° |
| 0° | −105° | −105° | 0° |
| 105° | 0° | 0° | 105° |

The position of the entries in table I and table II below correspond to position of the antenna elements 402 in the antenna element array 400. The set of phase shifts shown in Table I includes a first group of equal phase shifts of a first value (−105° applied to a first group of antenna elements 302 located at the center of the array of antenna elements, a second group of equal phase shifts of a second value (105°) applied to a second group of antenna elements 302 located at corners of the array of antenna elements and a third group of phase shifts having values (0°) that are between said first value and said second value applied to a third group of remaining antenna elements 302.

FIG. 6 is 3-D directivity plot 600 for the antenna element array 400 shown in FIG. 4 when configured to operate in a second non-directional mode. This second non-directional pattern is also distinguished from the usual directional patterns which are produced by phased array antennas. A set of phase shifts that can be established by the digital phase shifter array 206 in order to configure the phased array antenna 208 to produce the directivity pattern shown in FIG. 6 is shown in table II below.

TABLE II

| | | | |
|---|---|---|---|
| −105° | 0° | 0° | 105° |
| 0° | 105° | −105 | 0° |
| 0° | −105° | 105° | 0° |
| 105° | 0° | 0° | −105° |

The set of phase shifts shown in Table II include phase shifts for elements in a block of four elements at the center of the array of elements, including phase shifts for an upper left element and a lower right element in the block having a first value and phase shifts for a upper right and lower left element in the block having a second value; phase shifts for elements at corners of the array of elements, including phase shifts for the upper right corner element and lower left corner element having the first value, and phase shifts for the upper left corner element and lower right corner element having the second value; and phase shifts for remaining elements having values that are between the first value and the second value.

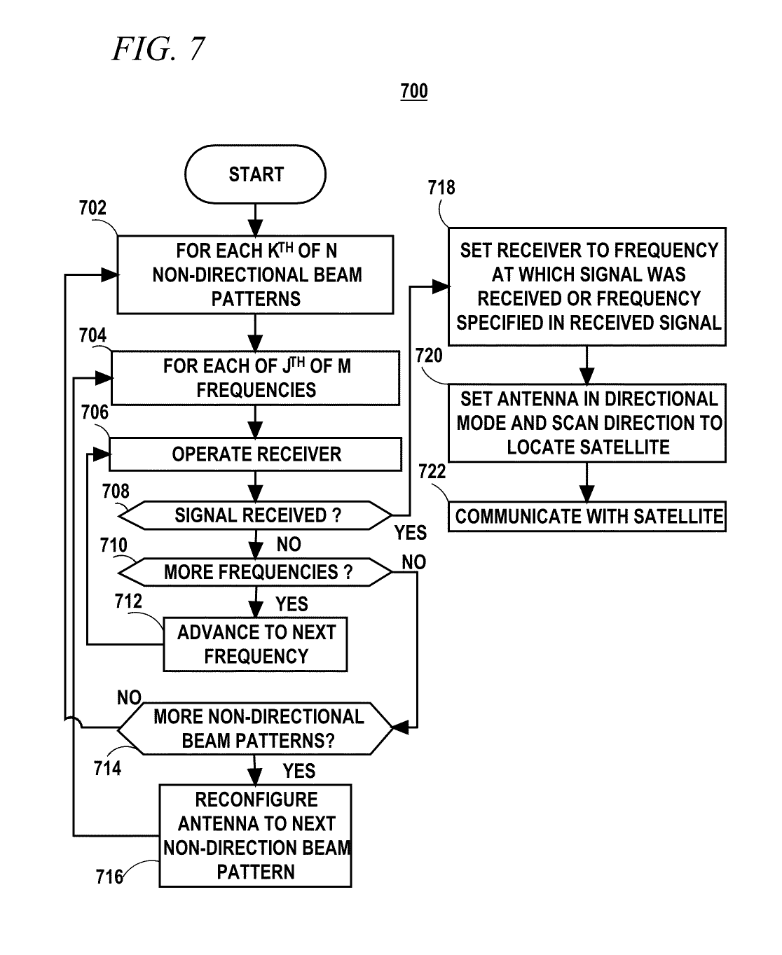

FIG. 7 is a flowchart of a method 700 of operating the mobile satellite radios 104, 200, 300 shown in FIG. 1, FIG. 2 and FIG. 3 according to an embodiment of the invention. Block 702 is the top of a loop that runs through each K^{TH} non-directional beam pattern of a plurality of N non-directional beam patterns. Two non-directional beam patterns are shown in FIG. 5 and FIG. 6. In certain embodiments only one non-directional beam pattern may be used, while in other embodiments more than one non-directional beam pattern may be used. One reason to use more than one non-directional beam pattern, is if each non-directional beam pattern for a particular antenna has certain angular regions of weak gain that are stronger in at least one other non-directional beam pattern.

Block 704 is the top of a loop that runs through each J^{TH} of a plurality of M frequency bands. In the case of certain embodiments the satellites 102 may be transmitting on an a priori unknown frequency out of a set of possible frequencies, thus the mobile satellite radio 104, 200, 300 may need to check multiple frequencies before finding a frequency that can be used for communications. As discussed above in the background section a satellite may cover different zones with different frequency bands and the mobile satellite radio may not have foreknowledge of the zone in which it is situated and the corresponding frequency band.

In block 706 the receiver (e.g., 306 or included in transceivers 204, 320) is operated to try to receive a signal. The LNA 222 in combination with the demodulator 224, decoder 214 and the local oscillator 218 can be said to constitute a receiver. Many other receiver architectures are known and can be used as alternatives. The outcome of succeeding decision block 708 depends on whether a signal was received in block 706. If the outcome of decision block 708 is negative meaning that no signal was received then the method proceeds to decision block 710 the outcome of which depends on whether more of the M frequencies remain to be tried.

If the outcome of decision block 710 is positive then in block 712, the method 700 advances to a next available frequency and thereafter loops back to block 706 to check for communications in a corresponding frequency band. If on the other hand, the outcome of decision block 710 is negative meaning that there are no more frequencies to be tried, then the method 700 branches to decision block 714 the outcome of which depends on whether there are more non-directional beam patterns to be tried.

If the outcome of decision block 714 is positive meaning that are more non-directional beam patterns to be tried then in block 716 the phased array antenna is reconfigured to the next non-directional beam pattern and thereafter the method returns to block 704 to begin checking through the plurality of M frequencies.

If on the other hand the outcome of decision block 714 is negative meaning that there are no more non-directional beam patterns to be checked then the method may loop back to block 702 to restart the process described above. Although not shown, a limit may be imposed on the number of re-executions of the entire search that are performed without user intervention. After a pre-programmed number of executions of the loop commenced in block 702 a user interface device (e.g., display screen, indicator light) may be used to alert the user that the search for a satellite signal was unsuccessful.

When the outcome of block 708 is positive meaning that a signal was received in block 706, the method 700 branches to block 718 in which the receiver (e.g., 306 or those included in transceivers 204, 320) is set to a frequency which was received in block 706 or is set to a frequency specified in the signal that was received in block 706 and decoded. In the latter case, in certain embodiments, the signal received in block 706 may be a control channel e.g., a broadcast control channel which bears information on available frequencies. Such a control channel may have higher energy per information symbol (e.g., bit) and thus may be more easily detected using a non-directional beam pattern. Additionally it should be noted that in certain embodiments when one is merely seeking to detect the frequency of a signal the higher error rate arising from the use of a non-directional antenna as opposed to a directional antenna may be tolerable.

Next in block 720 the phased array antenna is configured in a directional mode by proper selection of phase shifts established by the digital phase shifter array 206 as known in the art and the antenna aiming direction is scanned through a solid angle (e.g., scanned in both azimuth and elevation angle) to locate the satellite angularly. Thereafter in block 722 communication with and through the satellite is carried out. A program that performs the method 700 can be executed by the controllers 202, 312, 322 of the mobile satellite radios 104, 200, 300.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A mobile satellite radio comprising a receiver, a phased array antenna coupled to the receiver and a controller coupled to the phased array antenna and the receiver, wherein the controller is configured to:
configure the phased array antenna into at least one non-directional configuration;
receive signals from a satellite when operating in the at least one non-directional configuration;
determine frequency information when receiving signals from the satellite when operating in the at least one non-directional configuration.

2. The mobile satellite radio according to claim 1 wherein said controller is further configured to configure the phased array antenna into a directional configuration and operate at a frequency that is selected based on the frequency information.

3. The mobile satellite radio according to claim 2 wherein said controller is further configured to scan an aim direction of the phased array antenna to search a solid angle for the satellite while operating at the frequency that is selected based on the frequency information.

4. The mobile satellite radio according to claim 1 wherein, in determining frequency information, the controller is adapted to configure the receiver to listen for signals in a plurality of different frequency bands when operating in the at least one non-directional configuration.

5. The mobile satellite radio according to claim 4 wherein the controller is adapted to obtain frequency information by selecting a particular frequency band among the plurality of different frequency bands on which a signal was received.

6. The mobile satellite radio according to claim 1 wherein the controller is adapted to obtain frequency information by decoding frequency information included in a control channel.

7. A method of operating a mobile satellite radio, the method comprising:
receiving a signal from a satellite using a non-directional antenna beam pattern;
obtaining frequency information in the course of receiving the signal;
configuring the mobile satellite radio to communicate using a directional beam pattern and using a frequency selected based on the frequency information; and
communicating using the directional beam pattern and the frequency selected based on the frequency information.

8. A phased array antenna comprising an array of antenna elements coupled to a phase shifter array, wherein the phase shifter array is set to establish a set of phase shifts that cause the antenna to exhibit a non-directional beam pattern.

9. The phased array antenna according to claim 8 wherein the set of phase shifts includes a first group of substantially equal phase shifts of a first value applied to a first group of antenna elements disposed at a center of the array of antenna elements, a second group of substantially equal phase shifts of a second value applied to a second group of antenna elements disposed at corners of said array of antenna elements, a third group of phase shifts having values that are between said first value and said second value applied to a third group of antenna elements.

10. The phased array antenna according to claim 8 wherein the set of phase shifts includes:
phase shifts for elements in a block of four elements at a center of the array of elements, including phase shifts for an upper left element and a lower right element in the block having a first value and phase shifts for a upper right and lower left element in the block having a second value;
phase shifts for elements at corners of the array of elements, including phase shifts for the upper right corner element and lower left corner element having the first value, and phase shifts for the upper left corner element and lower right corner element having the second value; and
phase shifts for remaining elements having values that are between the first value and the second value.
